(19) United States
(12) Patent Application Publication
(10) Pub. No.: US 2018/0040408 A1
(43) Pub. Date: Feb. 8, 2018

(54) REACTOR

(71) Applicant: Panasonic Intellectual Prpoerty Management Co., Ltd., Osaka (JP)

(72) Inventors: JUNICHI KOTANI, Hyogo (JP); TOSHIYUKI ASAHI, Osaka (JP); HIDENORI UEMATSU, Osaka (JP)

(21) Appl. No.: 15/554,053

(22) PCT Filed: Mar. 22, 2016
(86) PCT No.: PCT/JP2016/001628

§ 371 Date: Aug. 28, 2017

(30) Foreign Application Priority Data
Apr. 7, 2015 (JP) 2015-078179

(51) Int. Cl. H01F 27/24; H01F 27/28

(52) U.S. Cl. CPC H01F 27/24; H01F 27/2823

(57) ABSTRACT

A reactor includes a core made of magnetic material and a coil wound around a part of the core. The core includes a first core part having both ends opposite to each other, a second core part having both ends opposite to each other, a third core part having both ends opposite to each other, and a fourth core part having both ends opposite to each other. The coil includes a first coil part wound around a part of the first core part and a second coil part wound around a part of the second core part. A cross-sectional area S₁ of the first core part perpendicular to a direction of a magnetic flux passing through the first core part, a cross-sectional area S₂ of the second core part perpendicular to a direction of a magnetic flux passing through the second core part, a cross-sectional area S₃ of the third core part perpendicular to a direction of a magnetic flux passing through the third core part, a cross-sectional area S₄ of the fourth core part perpendicular to a direction of a magnetic flux passing through the fourth core part, a length A₁ of the first winding part, a length A₂ of the second winding part, a length B₁ of the first non-winding part, and a length B₂ of the second non-winding part satisfy following relations: A₁+A₂<B₁+B₂; S₁>S₃; S₁>S₄; S₂>S₃; and S₂>S₄.

### TECHNICAL FIELD

The present invention relates to a reactor, a passive element utilizing an inductance.

### BACKGROUND ART

PTL1 discloses a reactor in which the cross-sectional area of a part of a core around which a coil is wound is larger than the cross-sectional area of a part of the core where the coil is not wound for the purpose of providing the reactor with a small size and improving a DC superposition characteristic for a large current flowing to the reactor.

PTL2 discloses a reactor in which the length of a core where a coil is not wound can be changed for the purpose of making inductance adjustable with a simple structure.

PTL3 discloses a reactor in which the ratio of a length of a part of a core around which a coil is wound to the length of a part of the core where the coils not wound is determined for the purpose of balanced installation and facilitating assembly.

### CITATION LIST

### Patent Literature

PTL1: Japanese Patent Laid-Open Publication No. 2007-243136

PTL2: Japanese Patent Laid-Open Publication No. 11-23826

PTL3: Japanese Patent Laid-Open Publication No. 2009-259971

### SUMMARY

A reactor includes a core made of magnetic material and a coil wound around a part of the core. The core includes a first core part having both ends opposite to each other, a second core part having both ends opposite to each other, a third core part having both ends opposite to each other, and a fourth core part having both ends opposite to each other. One end of the both ends of the first core part is connected to one end of the both ends of the third core part. Another end of the both ends of the third core part is connected to one end of the both ends of the second core part. Another end of the both ends of the second core part is connected to one end of the both ends of the fourth core part. Another end of the both ends of the fourth core part is connected to another end of the both ends of the first core part. The coil includes a first coil part wound around a part of the first core part, and a second coil part wound around a part of the second core part. The first core part includes a first winding part around which the first coil part is wound, a first region extending from the one end of the both ends of the first core part to the first winding part, and a second region extending from the another end of the both ends of the first core part to the first winding part. The first coil part is not wound around the first region. The first coil part is not wound around the second region. The second core part includes a second winding part around which the second coil part is wound, a third region extending from the one end of the both ends of the second core part to the second winding part, and a fourth region extending from the another end of the both ends of the second core part to the second winding part. The second coil part is not wound around the third region. The second coil part is not wound around the fourth region. The third core part, the first region of the first core part, and the third region of the second core part constitute a first non-winding part. The fourth core part, the second region of the first core part, and the fourth region of the second core part constitute a second non-winding part. A cross-sectional area S₁ of the first core part perpendicular to a direction of a magnetic flux passing through the first core part, a cross-sectional area S₂ of the second core part perpendicular to a direction of a magnetic flux passing through the second core part, a cross-sectional area S₃ of the third core part perpendicular to a direction of a magnetic flux passing through the third core part, a cross-sectional area S₄ of the fourth core part perpendicular to a direction of a magnetic flux passing through the fourth core part, a length A₁ of the first winding part, a length A₂ of the second winding part, a length B₁ of the first non-winding part, and a length B₂ of the second non-winding part satisfy following relations: A₁+A₂<B₁+B₂; S₁>S₃; S₁>S₄; S₂>S₃; and S₂>S₄.

This reactor reduces influence of heat and has a small size.

### BRIEF DESCRIPTION OF DRAWINGS

FIG. 1 is a perspective view of a reactor in accordance with Exemplary Embodiment 1.

FIG. 2 is a cross-sectional view of the reactor along line II-II shown in FIG. 1

FIG. 3 is a cross-sectional view of the reactor in accordance with Embodiment 1.

FIG. 4 is a cross-sectional view of the reactor along line IV-IV shown in FIG. 1.

FIG. 5 is a cross-sectional view of the reactor along line V-V shown in FIG. 1.

FIG. 6A shows characteristics of the reactor in accordance with Embodiment 1.

FIG. 6B shows an alternating-current loss of the reactor in accordance with Embodiment 1.

FIG. 7 is a cross-sectional view of a reactor in accordance with Exemplary Embodiment 2.

### DETAILED DESCRIPTION OF EMBODIMENT

### Exemplary Embodiment 1

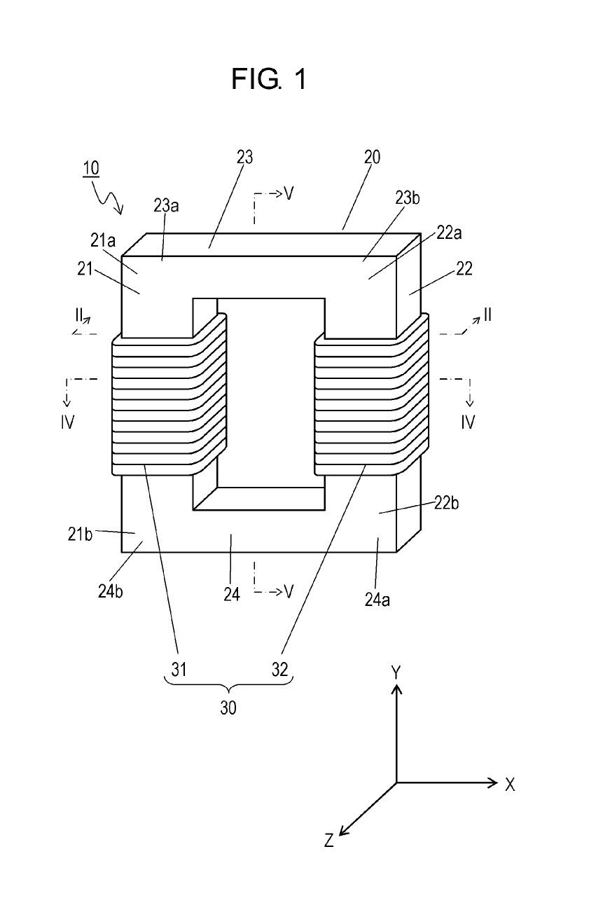

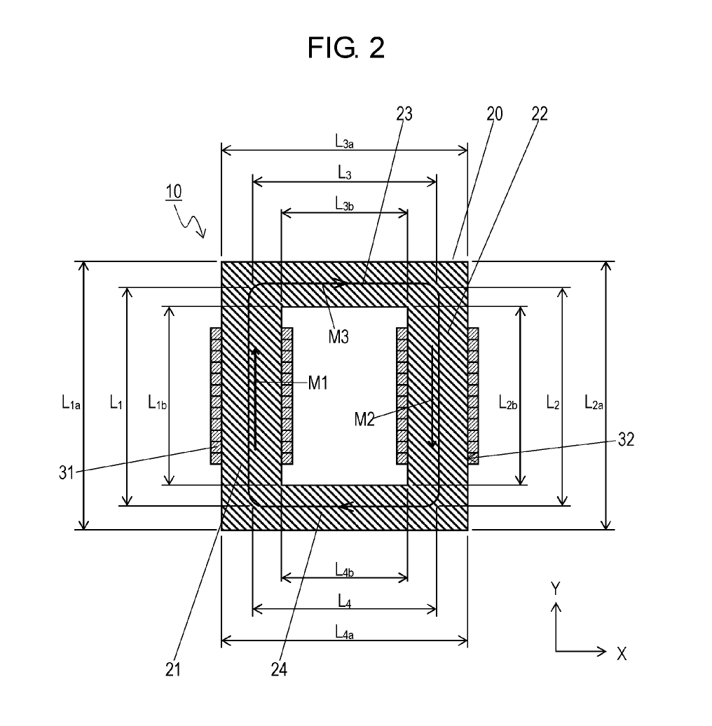

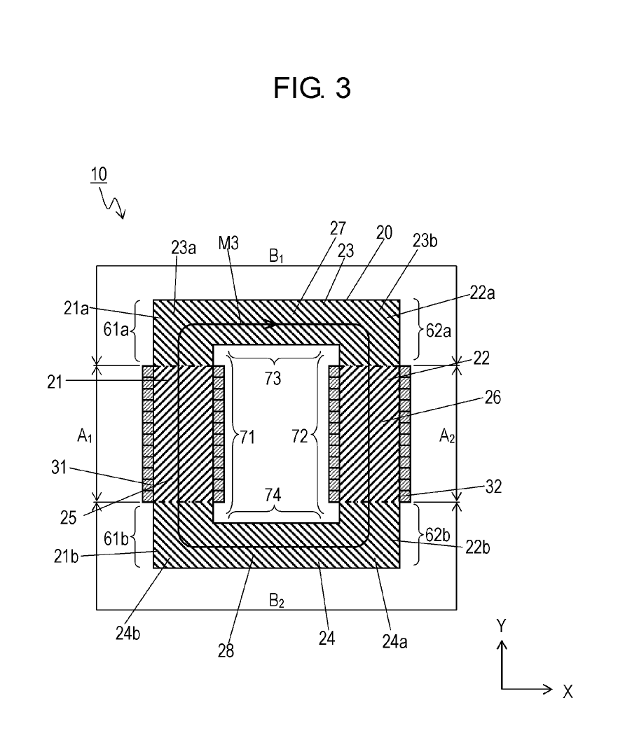

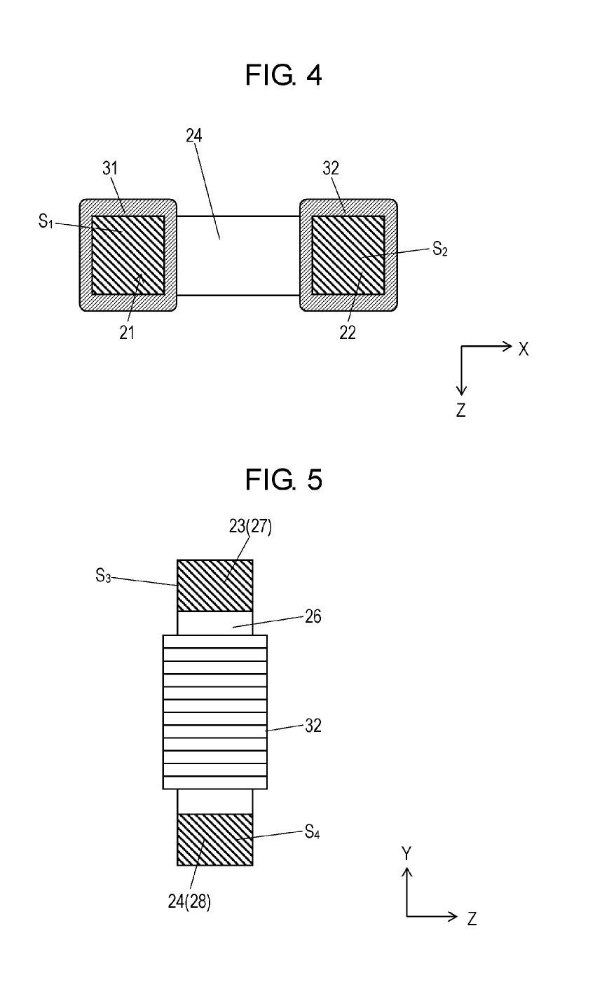

FIG. 1 is a perspective view of reactor 10 in accordance with Exemplary Embodiment 1. FIG. 2 is a cross-sectional view of reactor 10 along line II-II shown in FIG. 1 for illustrating a cross section of reactor 10 parallel to an XY plane. FIG. 3 is a cross-sectional view of reactor 10. FIG. 4 is cross-a sectional view of reactor 10 along line IV-IV shown in FIG. 1 for illustrating a cross section of reactor 10 parallel to an XZ plane. FIG. 5 is a cross-sectional view of reactor 10 along line V-V shown in FIG. 1 for illustrating a cross section of reactor 10 parallel to a YZ plane.

Reactor 10 includes core 20 and coil 30.

Core 20 is made of magnetic material. Core 20 includes core part 21, core part 22, core part 23, and core part 24. Core part 21 is connected to core part 23. Core part 23 is connected to core part 22. Core part 22 is connected to core part 24. Core part 24 is connected to core part 21. Core parts 21, 22, 23, and 24 are all made of the magnetic material. Core 20 has a rectangular annular shape. Reactor 10 has a smaller size than a reactor including a core, such as an EI type core, having another shape.

Core part 21 has both ends 21a and 21b opposite to each other. Core part 22 has both ends 22a and 22b opposite to each other. Core part 23 has both ends 23a and 23b opposite to each other. Core part 24 has both ends 24a and 24b opposite to each other. One end 21a of both ends 21a and 21b of core part 21 is connected to one end 23b of both ends 23a and 23b of core part 23. Another end 23b of both ends 23a and 23b of core part 23 is connected to one end 22a of both ends 22a and 22b of core part 22. Another end 22b of both ends 22a and 22b of core part 22 is connected to one end 24a of both ends 24a and 24b of core part 24. Another end 24b of both ends 24a and 24b of core part 24 is connected to another end 21b of both ends 21a and 21b of core part 21.

Coil 30 is made of a conductor. Coil 30 is wound around core 20. Coil 30 includes coil part 31 and coil part 32. Coil part 31 is electrically connected to coil part 32. Coil part 31 is wound around a part of core part 21. Coil part 32 is wound around a part of core part 22. In accordance with Embodiment 1, coil 30 is made of a copper wire having a rectangular cross section, but may not necessarily have such a cross section.

In FIGS. 1 to 5, an X axis, a Y axis, and a Z axis perpendicular to each other are defined. Magnetic fluxes M1 and M2 generated by coil part 31 and coil part 32 pass through core 20 in the same direction. For example, as shown in FIG. 1, at a moment when magnetic flux M1 generated by coil part 31 passes through core part 21 in a positive direction of the Y axis, through core part 22 in a negative direction of the Y axis, through core part 23 in a positive direction of the X axis, and through core part 24 in a negative direction of the X axis, magnetic flux M2 generated by coil part 32 passes through core parts 21 to 24 in the same directions as magnetic flux M1 generated by coil part 31. Magnetic fluxes M1 and M2 are added to form magnetic flux M3 passing through each part of core 20.

FIG. 2 shows length L₁ of core part 21 in a direction in which magnetic flux M3 passes, length L₂ of core part 22 in a direction in which magnetic flux M3 passes, length L₃ of core part 23 in a direction in which magnetic flux M3 passes, and length L₄ of core part 24 in a direction in which magnetic flux M3 passes. Length L₁ of core part 21 is the mean value of outer length L₁ₐ of core part 21 and inner length L_{1b} of core part 21. Similarly, length L₂ of core part 22 is the mean value of outer length L₂ₐ of core part 22 and inner length L_{2b} of core part 22. Length L₃ of core part 23 is the mean value of outer length L₃ₐ of core part 23 and inner L_{3b} of core part 23. Length L₄ of core part 24 is the mean value of inner length L₄ₐ of core part 24 and inner length L_{4b} of core part 24. In accordance with Embodiment 1, lengths L₁ to L₄ satisfy relations: L₁=L₂; and L₃=L₄.

As shown in FIG. 3, core 20 is partitioned into four parts: winding part 25, winding part 26, non-winding part 27, and non-winding part 28. Winding part 25 is a region of core part 21 around which coil part 31 is wound. Winding part 26 is a region of core part 22 around which coil part 32 is wound. Non-winding part 27 is a region including core part 23, a portion of core part 21 connected to core part 23 except for winding part 25, and a portion of core part 22 connected to core part 23 except for winding part 26. Non-winding part 28 includes core part 24, a portion of core part 21 connected to core part 24 except for winding part 25, and a portion of core part 22 connected to core part 24 except for winding part 26.

Core part 21 includes winding part 25 around which coil part 31 is wound, region 61a extending from one end 21a of core part 21 to winding part 25, and region 61b extending from another end 21b of core part 21 to winding part 25. Coil part 31 is not wound around any of regions 61a and 61b. Core part 22 includes winding part 26 around which coil part 32 is wound, region 62a extending from one end 22a of coil part 22 to winding part 26, and region 62b extending from another end 22b of core part 22 to winding part 26. Coil part 32 is not wound around any of regions 62a and 62b. Core part 23, region 61a of core part 21, and region 62a of core part 22 constitute non-winding part 27. Core part 24, region 61b of core part 21, and region 62b of core part 22 constitute non-winding part 28.

Core 20 has an annular shape. In accordance with Embodiment 1, core 20 has a rectangular annular shape. Winding part 26 is located away from winding part 25 along the annular shape. Non-winding part 27 extends from winding part 25 to winding part 26 along the annular shape. Non-winding part 28 extends from winding part 25 to winding part 26 along the annular shape, and is located opposite to non-winding part 27 with respect to winding parts 25 and 26.

Winding part 25 has length A₁ in a direction of magnetic flux M3 passing through winding part 25. Winding part 26 has length A₂ in a direction of magnetic flux M3 passing through winding part 26. Non-winding part 27 has length B₁ along magnetic flux M3 that passes through non-winding part 27. Non-winding part 28 has length B₂ along magnetic flux M3 that passes through non-winding part 28. In the embodiment, winding part 25 is located at the center of core part 21 in the length direction, and winding part 26 is at the center of core part 22 in the length direction. Accordingly, the following relations are satisfied.

B₁=L₃+(L₁−A₁)/2+(L₂−A₂)/2

B₂=L₄+(L₁−A₁)/2+(L₂−A₂)/2

Since L₁=L₂, L₃=L₄, and A₁=A₂ in accordance with the embodiment, the following relation is also satisfied.

B₁=L₃+L₁−A₁=L₄+L₂−A₂=B₂

The rectangular annular shape of core 20 includes a pair of opposite sides 71 and 72, and a pair of opposite sides 73 and 74. Each of core parts 21 to 24 linearly extends to constitute respective one of four sides 71 to 74 of the rectangular annular shape (see FIG. 3). Winding part 25 is provided at one opposite side 71 of the pair of opposite sides 71 and 72. Winding part 26 is provided at another opposite side 72 of the pair of opposite sides 71 and 72. Non-winding part 27 includes one opposite side 73 of the pair of opposite sides 73 and 74. Non-winding part 28 includes another opposite side 74 of the pair of opposite sides 73 and 74.

Reactors have been used in electric circuits to which a large current is applied. Upon having a large current flowing in, the reactor generates large heat. When the reactor generates such large heat, the reactor itself or electronic components disposed around the reactor are thermally affected.

Reactors have been demanded to have small sizes according to a demand to electronic components to have small sizes. However, in view of heat generation, a large reactor is preferable due to heat capacity and heat release area. A simple downsizing of the reactor may result in increasing the temperature of the reactor.

In reactor 10 in accordance with Embodiment 1, both of cross-sectional areas S₃ and S₄ of core parts 23 and 24 in a direction perpendicular to magnetic flux M3 passing core parts 23 and 24 where coil 30 is not wound are smaller than both of cross-sectional areas S₁ and S₂ of core parts 21 and 22 in a direction perpendicular to magnetic flux M3 passing core parts 21 and 22 around which coil 30 is wound. More specifically, cross-sectional areas S₁, S₂, S₃, and S₄ satisfy relations: S₁>S₃, S₁>S₄, S₂>S₃, and S₂>S₄ in reactor 10. Even if cross-sectional areas S₃ and S₄ of core parts 23 and 24 where magnetic flux M3 is relatively small are small, an influence of heat generation is small, hence providing the rector with a small size. The reduction of cross-sectional areas S₃ and S₄ of core parts 23 and 24 less influence on inductance than the reduction of cross-sectional areas S₁ and S₂ of core parts 21 and 22 where magnetic flux M3 is relatively large. Reactor 10 thus suppresses the decrease of the inductance.

In reactor 10 in accordance with the embodiment, the sum of lengths A₁ and A₂ of winding parts 25 and 26 is shorter than the sum of lengths B₁ and B₂ of non-winding parts 27 and 28. In other words, lengths A₁, A₂, B₁, and B₂ satisfy a relation: A₁+A₂<B₁+B₂. This relation reduces a loss due to insides of coil parts 31 and 32 being close to each other.

Magnetic flux M3 is larger in winding parts 25 and 26 of core 20 that are regions around which coil parts 31 and 32 are wound than other regions. However, in reactor 10, a distance between regions with large dimensional change is small to reduce a dimensional change due to magnetostriction. Accordingly, reactor 10 has less vibration and thus less vibration noise.

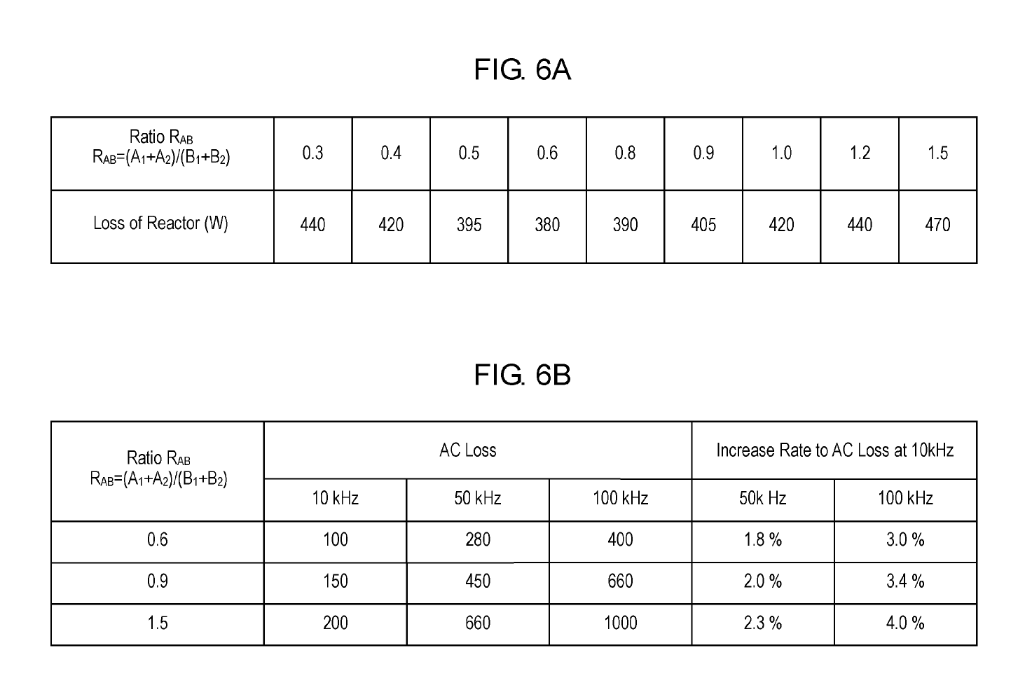

FIG. 6A shows characteristics of reactor 10. More specifically, FIG. 6A shows a relation between a loss of reactor 10 and ratio R_{AB} (R_{AB}=(A₁+A₂)/(B₁+B₂)) which is the ratio of sum (A₁+A₂) of length A₁ of winding part 25 and length A₂ of winding part 26 to sum (B₁+B₂) of length B₁ of non-winding part 27 and length B₂ of non-winding part 28.

With respect to circuitry efficiency, the loss of reactor 10 is preferably less than 420 W. When ratio R_{AB} exceeds 0.9, the coil loss becomes large. When ratio R_{AB} is less than 0.5, the coil loss can be suppressed, but a core loss becomes large. In addition, ratio R_{AB} equal to or smaller than 0.3 allows lengths of the winding parts to be extremely short, and prevents the coil from being wound easily. Accordingly, lengths A₁, A₂, B₁, and B₂ preferably satisfy the relation: (B₁+B₂)×0.5<A₁+A₂<(B₁+B₂)×0.9

Cross-sectional areas S₁, S₂, S₃, and S₄ of core parts 21, 22, 23, and 24 preferably satisfy the following relations.

S₁×0.6<S₃<S₁;

S₁×0.6<S₄<S₁;

S₂×0.6<S₃<S₂; and

S₂×0.6<S₄<S₂.

Reactor 10 can have a small size without causing magnetic saturation when cross-sectional areas S₁, S₂, S₃, and S₄ satisfy the above relations.

In reactor 10 in accordance with the embodiment, length L₃ of core part 23 in a direction of magnetic flux M3 passing through core part 23 and length L₄ of core part 24 in a direction of magnetic flux M3 passing through core part 24 where coil 30 is not wound may be shorter than any of length L₁ of core part 21 in a direction of magnetic flux M3 and length L₂ of core part 22 in a direction of magnetic flux M3 where coil 30 is wound. In other words, reactor 10 may satisfy relations: L₁>L₃; L₁>L₄; L₂>L₃; and L₂>L₄. The above relations of lengths L₁, L₂, L₃, and L₄ provide reactor 10 with a small size.

FIG. 6B shows a relation of a frequency and an alternating-current (AC) loss in a copper wire of the coil parts when ripple current is the same in samples with ratio R_{AB} of 0.6, 0.9, and 1.5. FIG. 6B shows AC losses in the copper wire at ratios R_{AB} and frequencies whereas the AC loss in copper wire is 100 when ratio R_{AB} is 0.6 and a frequency is 10 kHz. FIG. 6B also shows an increase rate of the AC loss at frequencies 50 kHz to 100 kHz with respect to the AC loss at frequency 10 kHz.

As shown in FIG. 6B, the increase rate of the AC loss increases as the frequency increases. The increase rate is extremely high when ratio RAE becomes 1.5. In this regard, a significant effect is obtained at high frequencies when the following expression is satisfied:

(B₁+B₂)×0.5<A₁+A₂<(B₁+B₂)×0.9.

### Exemplary Embodiment 2

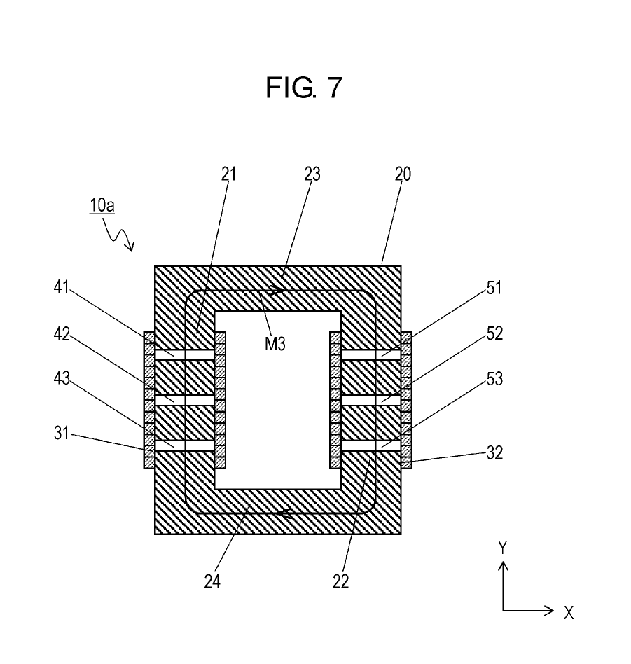

FIG. 7 is a sectional view of reactor 10a in accordance with Exemplary Embodiment 2 for illustrating a cross section of reactor 10a parallel to the XY-plane. In FIG. 7, components identical to those of reactor 10 in accordance with Embodiment 1 shown in FIGS. 1 to 5 are denoted by the same reference numerals.

In reactor 10a in accordance with Embodiment 2, gaps 41, 42, and 43 are provided in core part 21 while gaps 51, 52, and 53 are provided in core part 22.

Gaps 41, 42, and 43 are positioned in winding part 25. Gaps 51, 52, and 53 are positioned in winding part 25.

Gaps 41 to 43 divide winding part 25 in a direction of magnetic flux M3 passing through winding part 25. Gaps 41 to 43 are arranged in a direction of magnetic flux M3 passing through winding part 25. Similarly, gaps 51 to 53 divide winding part 26 in a direction of magnetic flux M3 passing through winding part 26. Gaps 51 to 53 are arranged in a direction of magnetic flux M3 passing through winding part 26.

The gaps provided in winding parts 25 and 26 effectively causes a magnetic field applied to core 20 to be smaller than a magnetic field applied to the gaps, compared to the case of providing a gap in a portion of core 20 outside winding parts 25 and 26. This configuration improves a direct-current (DC) superimposition characteristic while allowing the gaps to have small sizes.

### INDUSTRIAL APPLICABILITY

A reactor according to the present invention is effectively applicable to passive elements utilizing an inductance.

### REFERENCE MARKS IN THE DRAWINGS

10, 10a reactor
20 core
21 core part (first core part)
22 core part (second core part)
23 core part (third core part)
24 core part (fourth core part)
25 winding part (first winding part)
26 winding part (second winding part)
27 non-winding part (first non-winding part)
28 non-winding part (second non-winding part)
30 coil
31 coil part (first coil part)
32 coil part (second coil part)
41 gap (first gap)
42 gap (third gap)
43 gap
51 gap (second gap)
52 gap (fourth gap)
53 gap

1. A reactor comprising:
a core made of magnetic material; and
a coil wound around a part of the core, wherein
the core includes a first core part having both ends opposite to each other, a second core part having both ends opposite to each other, a third core part having both ends opposite to each other, and a fourth core part having both ends opposite to each other,
one end of the both ends of the first core part is connected to one end of the both ends of the third core part,
another end of the both ends of the third core part is connected to one end of the both ends of the second core part,
another end of the both ends of the second core part is connected to one end of the both ends of the fourth core part,
another end of the both ends of the fourth core part is connected to another end of the both ends of the first core part,
the coil includes a first coil part and a second coil, the first coil part being wound around a part of the first core part, the second coil part being wound around a part of the second core part,
the first core part includes:
a first winding part around which the first coil part is wound;
a first region extending from the one end of the both ends of the first core part to the first winding part, the first coil part not being wound around the first region; and
a second region extending from the another end of the both ends of the first core part to the first winding part, the first coil part not being wound around the second region,
the second core part includes:
a second winding part around which the second coil part is wound;
a third region extending from the one end of the both ends of the second core part to the second winding part, the second coil part not being wound around the third region; and
a fourth region extending from the another end of the both ends of the second core part to the second winding part, the second coil part not being wound around the fourth region,
the third core part, the first region of the first core part, and the third region of the second core part constitute a first non-winding part,
the fourth core part, the second region of the first core part, and the fourth region of the second core part constitute a second non-winding part, and
a cross-sectional area S1 of the first core part perpendicular to a direction of a magnetic flux passing through the first core part, a cross-sectional area S2 of the second core part perpendicular to a direction of a magnetic flux passing through the second core part, a cross-sectional area S3 of the third core part perpendicular to a direction of a magnetic flux passing through the third core part, a cross-sectional area S4 of the fourth core part perpendicular to a direction of a magnetic flux passing through the fourth core part, a length A1 of the first winding part, a length A2 of the second winding part, a length B1 of the first non-winding part, and a length B2 of the second non-winding part satisfy following relations:
A1+A2<B1+B2;
S1>S3;
S1>S4;
S2>S3; and
S2>S4.

2. The reactor of claim 1, wherein the cross-sectional area S1, the cross-sectional area S2, the cross-sectional area S3, the cross-sectional area S4, the length A1, the length A2, the length B1, and the length B2 satisfy following relations:
(B1+B2)×0 5<A1+A2<(B1+B2)×0.9;
S1×0.6<S3<S1;
S1×0.6<S4<S1;
S2×0.6<S3<S2; and
S2×0.6<S4<S2.

3. The reactor of claim 2, wherein a length L1 of the first core part in the direction of the magnetic flux passing through the first core part, a length L2 of the second core part in the direction of the magnetic flux passing through the second core part, a length L3 of the third core part in the direction of the magnetic flux passing through the third core part, and a length L4 of the fourth core part in the direction of the magnetic flux passing through the fourth core part satisfy following relations:
L3<L1;
L4<L1;
L3<L2; and
L4<L2,

4. The reactor of claim 1, wherein the core has a rectangular annular shape.

5. The reactor of claim 4, wherein each of the first core part, the second core part, the third core part, and the fourth core part extends linearly to constitute respective one of four sides of the rectangular annular shape.

6. The reactor of claim 1, wherein
the first core part is divided by a first gap in the direction of the magnetic flux passing through the first core part, the first gap being provided in the first winding part, and
the second core part is divided by a second gap in the direction of the magnetic flux passing through the second core part, the second gap being provided in the second winding part.

7. The reactor of claim 6, wherein the first winding part is divided by a third gap in the direction of the magnetic flux passing through the first winding part, the third gap being provided in the first winding part.

8. The reactor of claim 7, wherein the second winding part is divided by a fourth gap in the direction of the magnetic flux passing through the second winding part, the fourth gap being provided in the second winding part.
